(19) United States
(12) Patent Application Publication
(10) Pub. No.: US 2026/0226579 A1
(43) Pub. Date: Aug. 6, 2026

(54) BATTERY TREATMENT METHOD

(71) Applicants: HONDA MOTOR CO., LTD., MINATO-KU, TOKYO (JP); Nittetsu Mining Co., Ltd., Chiyoda-ku, Tokyo (JP)

(72) Inventors: Takayuki SAKATA, WAKO-SHI (JP); Mitsumasa SORAZAWA, WAKO-SHI (JP); Yushi FUJINAGA, WAKO-SHI (JP); Satoru TAKAHASHI, WAKO-SHI (JP); Hidekazu MATSUOKA, Tokyo (JP); Yuri OKAMOTO, Tokyo (JP)

(21) Appl. No.: 19/044,759

(22) Filed: Feb. 4, 2025

(30) Foreign Application Priority Data
Mar. 29, 2024 (JP) 2024-056136

(51) Int. Cl. C22B 7/00; C22B 3/00; C22B 3/22; C22B 15/00; C22B 47/00; H01M 10/54

(52) U.S. Cl. CPC C22B 7/006; C22B 3/22; C22B 15/0086; C22B 23/0453; C22B 47/00; H01M 10/54

(57) ABSTRACT

A battery treatment method for an all-solid-state battery including a positive electrode, a negative electrode, and a sulfide-based solid electrolyte, with the positive electrode having a positive electrode mixture including a positive electrode active material, the all-solid-state battery being formed using a copper member, the battery treatment method including: a deactivation step of deactivating contents of the target battery under a condition facilitating sulfidation of the copper member; a separation step of separating the positive electrode mixture from a material constituting the positive electrode; a treatment step of forming a slurry including the positive electrode mixture separated in the separation step; a flotation separation step of removing, from the slurry, solid content originating from the copper member through flotation separation; and a recovery step of recovering the positive electrode active material from the slurry from which the solid content is removed in the flotation separation step.

### INCORPORATION BY REFERENCE

The present application claims priority under 35 U.S.C. § 119 to Japanese Patent Application No. 2024-056136 filed on Mar. 29, 2024. The content of the application is incorporated herein by reference in its entirety.

### BACKGROUND OF THE INVENTION

### Field of the Invention

The present invention relates to a battery treatment method.

### Description of the Related Art

In recent years, research and development on recycling of secondary batteries, which contribute to improving energy efficiency, have been conducted to ensure access to affordable, reliable, sustainable, and advanced energy for a larger number of people. For example, some lithium-ion batteries and all-solid-state batteries are provided with a laminated electrode in which a positive electrode plate and a negative electrode plate are laminated via a separator. A ternary positive electrode material (NCM) composed of nickel, cobalt, and manganese is used as a positive electrode mixture of such kind of batteries. Therefore, methods for recovering valuable metals, such as NCM, from used secondary batteries have been conventionally proposed.

For example, International Publication No. WO 2010/106618 discloses a method of immersing a battery component that includes a sulfide-based solid electrolyte material in a treatment liquid including water to generate hydrogen sulfide, and thereby dissolving lithium included in the sulfide-based solid electrolyte material.

Secondary batteries use metal materials such as aluminum and copper. For example, copper foil is used as a negative electrode current collector. When a positive electrode material including nickel, cobalt, manganese, and the like is recovered from a secondary battery, these metal materials may contaminate the positive electrode material. Therefore, suppressing contamination by metal materials has been desired in order to enhance efficiency of positive electrode material recovery.

In order to solve the above problem, the purpose of the present application is to attempt to improve recovery efficiency by suppressing contamination by other metals in a step of recovering a valuable metal including nickel, cobalt, or manganese from a used secondary battery, contributing to enhancement of energy efficiency.

### SUMMARY OF THE INVENTION

One aspect of the present disclosure is a battery treatment method for an all-solid-state battery as a target battery, the all-solid-state battery including a positive electrode, a negative electrode, and a sulfide-based solid electrolyte, with the positive electrode having a positive electrode mixture including a positive electrode active material, the all-solid-state battery being formed using a copper member, the battery treatment method including: a deactivation step of deactivating contents of the target battery under a condition facilitating sulfidation of the copper member; a separation step of separating the positive electrode mixture from a material constituting the positive electrode; a treatment step of forming a slurry including the positive electrode mixture separated in the separation step; a flotation separation step of removing, from the slurry, solid content originating from the copper member through flotation separation; and a recovery step of recovering the positive electrode active material from the slurry from which the solid content is removed in the flotation separation step.

According to one aspect of the present disclosure, contamination by a metal originating from a copper member of a battery is suppressed in a step of recovering a valuable metal including nickel, cobalt, or manganese from a used secondary battery, attempting to improve efficiency of valuable metal recovery.

### BRIEF DESCRIPTION OF THE DRAWINGS

FIG. 1 is a diagram illustrating a target battery as an example of a battery to which the present disclosure is applied;

FIG. 2 is a diagram illustrating a battery treatment method; and

FIG. 3 is a schematic diagram illustrating a treatment example in a flotation separation step.

### DETAILED DESCRIPTION OF THE INVENTION

Hereinafter, an embodiment of the present invention will be described with reference to drawings.

### 1. Configuration of Target Battery

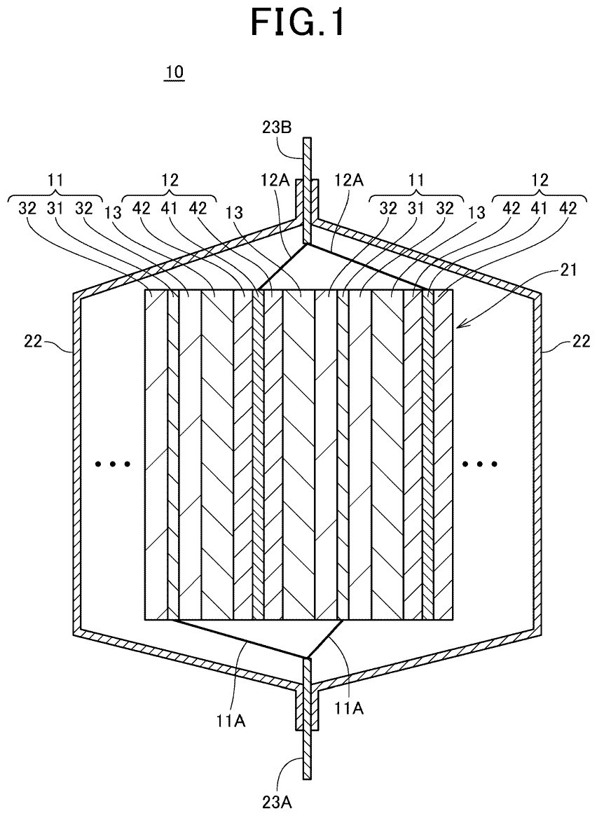

FIG. 1 is a diagram illustrating a configuration of a target battery 10 as an example of a battery to which the present disclosure is applied, the diagram schematically illustrating a cross-section of the target battery 10. The target battery 10 is a secondary battery which is chargeable and dischargeable. The target battery 10 described in the present embodiment is a laminated battery in which a battery material is sealed in a laminate material 22, and has a flat shape as a whole. The target battery 10 can be referred to as a pouch battery, a laminated battery cell, a pouch battery cell, a lithium-ion battery cell, a battery module, and the like.

The target battery 10 is a secondary battery commonly referred to as a lithium-ion battery, which attracts attention as a power storage device with high energy density. Examples of positive electrode active materials of lithium-ion batteries include lithium cobalt oxide, lithium nickel oxide, lithium manganese oxide, and lithium iron phosphate. In addition, a ternary positive electrode material (NCM) containing nickel, cobalt, and manganese can also be used as a positive electrode active material. As a negative electrode active material in a lithium-ion battery, a carbon-based material is used, for example. In addition, an all-solid-state battery using a solid electrolyte as a lithium-ion battery electrolyte is known.

Nickel, cobalt, and manganese, which are used as positive electrode active materials in lithium-ion batteries and all-solid-state batteries, are known as valuable metals and are required to be recovered from used batteries. Therefore, the present embodiment discloses a method for efficiently treating these batteries. In the treatment method disclosed herein, an electrode material to be recovered is a valuable metal included in the target battery 10, and more specifically is a compound associated with NCM included in a positive electrode active material of a positive electrode current collector 31. That is, the electrode material to be recovered is a substance including one or more of nickel, cobalt, and manganese.

More specifically, the positive electrode active material is a substance capable of occluding and releasing Li ions, and examples thereof can include a layered positive electrode active material, a spinel-type positive electrode active material, and an olivine-type positive electrode active material. Examples of the layered positive electrode active material can include LiCoO₂, LiNiO₂, LiCo_{1/3}Ni_{1/3}Mn_{1/3}O₂, LiVO₂, and LiCrO₂. Examples of the spinel-type positive electrode active material can include LiMn₂O₄, LiCoMnO₄, Li₂NiMn₃O₈, and LiNi_{0.5}Mn_{1.5}O₄. Examples of the olivine-type positive electrode active material can include LiCoPO₄, LiMnPO₄, and LiFePO₄.

As illustrated in FIG. 1, the target battery 10 has a configuration in which a laminated electrode 12 is housed in a laminate material 22. The laminate material 22 is a laminate film having a metal material such as aluminum alloy or stainless steel as a base material, for example. The laminate material 22 functions as an outer casing of the target battery 10 and as a sealing body that encloses the laminated electrode 21.

The target battery 10 of the present embodiment has a flat shape formed by bonding two sheets of the laminate material 22, and a pair of current collector tabs 23A and 23B for extracting power from the target battery 10 penetrates the outer casing and is exposed from ends of the target battery 10.

The laminated electrode 21 is a multilayered body in which a positive electrode plate 11 and a negative electrode plate 12 are laminated, and a separator 13 is disposed between each adjacent pair of the positive electrode plate 11 and the negative electrode plate 12. The separator 13 is disposed between the positive electrode plate 11 and the negative electrode plate 12 and prevents short-circuit between the positive electrode plate 11 and the negative electrode plate 12.

The positive electrode plate 11 and the negative electrode plate 12 are alternatively disposed, and one positive electrode plate 11 and one negative electrode plate 12 facing each other form one polar plate pair. The laminated electrode 21 is formed by laminating a plurality of polar plate pairs.

The positive electrode plate 11 includes a rectangular positive electrode current collector 31, and a positive electrode mixture 32 is provided on both sides of the positive electrode current collector 31. The positive electrode current collector 31 is, for example, aluminum foil or an aluminum plate. The positive electrode mixture 32 includes, for example, a positive electrode active material, a conductive material, a conductive assistant, and a binder. The positive electrode plate 11 has a positive electrode terminal 11A extending from an end of the positive electrode plate 11. The positive electrode terminals 11A extending from multiple positive electrode plates 11 forming the laminated electrode 21 are each connected to a current collector tab 23A.

The negative electrode plate 12 includes a rectangular negative electrode current collector 41. A negative electrode mixture 42 is provided on a side of the negative electrode current collector 41 facing the positive electrode plate 11. Copper foil or a copper plate is used for the negative electrode current collector 41, for example. The negative electrode current collector 41 is one example of a copper member. The negative electrode plate 12 has a negative electrode terminal 12A extending from an end of the negative electrode plate 12. The negative electrode terminals 12A extending from multiple negative electrode plates 12 forming the laminated electrode 21 are each connected to a current collector tab 23B.

The current collector tabs 23A and 23B are formed from a sheet-shaped metal material such as copper or aluminum, pass through the two sheets of laminate material 22, and are exposed to the outside.

The target battery 10 of the present embodiment has a solid electrolyte as an electrolyte and is, in particular, a battery using a sulfide-based solid electrolyte. The solid electrolyte is, for example, disposed between the positive electrode plate 11 and the negative electrode plate 12 in place of the separator 13. In this case, the solid electrolyte also has a function to prevent short-circuit between the positive electrode plate 11 and the negative electrode plate 12 in addition to a function as the electrolyte.

The sulfide solid electrolyte material is not particularly limited as long as it has Li and S and has Li-ion conductivity. In addition, Li included in the sulfide solid electrolyte material is usually dissolved in a treatment liquid such as water. It is further preferable that the sulfide solid electrolyte material leave no insoluble component when reacted with the treatment liquid. This is because the positive electrode active material is easily recovered.

Examples of the sulfide solid electrolyte material can include a material having Li, S, and a third component A. Examples of the third component A can include at least one selected from the group consisting of P, Ge, B, Si, I, Al, Ga, and As. Among them, in the present invention, the sulfide solid electrolyte material is preferably a compound using Li₂S and a sulfide MS other than Li₂S. Specific examples can include a Li₂S—P₂S₅ compound, a Li₂S—SiS₂ compound, and a Li₂S—GeS₂ compound, and a Li₂S—P₂S₅ compound is preferable among them because Li ion conductivity is high. Furthermore, when the molar ratio between Li₂S and the sulfide MS is defined as xLi₂S−(100−x)MS, x preferably satisfies the relationship 50≤x≤95 and more preferably satisfies the relationship 60≤x≤85. Note that the Li₂S—P₂S₅ compound means a sulfide solid electrolyte material using Li₂S and P₂S₅. The same is true of other compounds. For example, an amorphous Li₂S—P₂S₅ compound can be obtained by conducting a mechanical milling method or a melt-quenching method using Li₂S and P₂S₅, for example.

The sulfide solid electrolyte material of the present invention may be amorphous or crystalline. A crystalline sulfide solid electrolyte material can be obtained by baking an amorphous sulfide solid electrolyte material, for example. In addition, the sulfide solid electrolyte material of the present invention preferably has cross-linked sulfur. This is because the sulfide solid electrolyte material has high Li-ion conductivity. When the sulfide solid electrolyte material has cross-linked sulfur, hydrogen sulfide is more likely to be generated, providing the advantage of facilitating dissolution of Li included in the sulfide solid electrolyte material into the treatment liquid. In addition, in the present invention, in particular, the sulfide solid electrolyte material is preferably Li₇P₃S₁₁, because Li-ion conductivity is high. Note that Li₇P₃S₁₁ is sulfide glass ceramic of a Li₂S-P₂S₅ compound. In addition, in the present invention, the sulfide solid electrolyte material is preferably a thio-LISICON compound and is preferably, for example, a compound represented by LiₐP_{b}Ge_{c}S_{d} (2.8≤a≤4.2, 0.1≤b≤1.2, 0.1≤c≤1.2, and 3≤d≤5). The average particle diameter of the sulfide solid electrolyte material falls within, for example, a range of 1 nm to 100 μm and preferably falls within a range of 10 nm to 30 μm in particular.

### 2. Battery Treatment Method

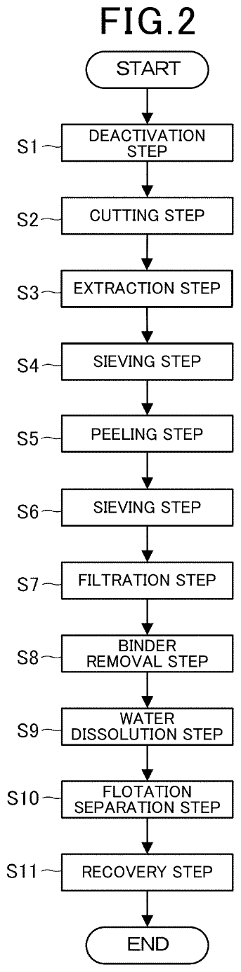

FIG. 2 is a diagram illustrating a battery treatment method.

In a deactivation step S1, contents of the target battery 10 are deactivated. In the deactivation step S1, the laminate material 22 is opened or cut to make the contents of the target battery 10 accessible to a treatment liquid, and the contents of the target battery 10 are then deactivated using the treatment liquid. Water, methyl alcohol, ethyl alcohol, acetone, or another liquid can be used as the treatment liquid, water is used in the present embodiment.

In the deactivation step S1, water vapor is used to react the sulfide-based solid electrolyte of the target battery 10 with water. For example, the target battery 10 is opened so that at least a portion of the contents is exposed, and the opened target battery 10 is placed in a water vapor atmosphere. Specifically, a method of placing the target battery 10 in a treatment container where water vapor is present is exemplified. In this case, the interior of the treatment container is a highly humid environment with humidity of a predetermined level or higher. In addition, the interior of the treatment container may be set to be a high-temperature and humidity environment. That is, the interior of the treatment container is set at a predetermined temperature or higher with humidity of a predetermined level or higher. The predetermined humidity level is, for example, 80% or higher. The predetermined temperature is higher than room temperature and is preferably a temperature not promoting change in the forms (oxidation or the like) of nickel, cobalt, and manganese included in the positive electrode active material. For example, the temperature is 50° C. or higher and 200° C. or lower.

In the deactivation step S1, the contents of the target battery 10 are not exposed to liquid water and exposed to water vapor so that the sulfide-based solid electrolyte of the target battery 10 is not deactivated in a short time. Therefore, in the deactivation step S1, sulfides including hydrogen sulfide (H₂S) are generated from the sulfide-based solid electrolyte. Hydrogen sulfide and other sulfides generated in this step sulfurize the copper foil or copper plate used in the negative electrode current collector 41, producing copper sulfides (including CuS, Cu₂S, and one or more copper sulfides having a composition different therefrom). That is, the deactivation step S1 is executed under a condition that facilitate sulfidation of the copper member of the target battery 10, and by generating significant amounts of hydrogen sulfide and other sulfides from the sulfide-based solid electrolyte, and at least a surface of the copper foil or copper plate in the negative electrode current collector 41 is thus changed to copper sulfide.

In the deactivation step S1, ventilation, exhaust and intake, neutralization treatment, or the like may be performed according to excess hydrogen sulfide unreacted with copper and to other gases generated.

Prior to the deactivation step S1, the laminate material 22 may be removed from the target battery 10, and the contents thereof may be taken out. This case is advantageous because aluminum originating from the laminate material 22 is not mixed in steps described later.

A cutting step S2 is conducted after the deactivation step S1. In the cutting step S2, the deactivated target battery 10 is crushed or cut using a shredder or another cutting device. Fragments of the target battery 10 cut in the cutting step S2 are referred to as cut pieces.

The cut pieces cut in the cutting step S2 are treated in an extraction step S3. In the extraction step S3, the treatment liquid is added to the cut pieces to dissolve a soluble component included in the cut pieces into the treatment liquid. An alcohol or water can be used as the treatment liquid, and water is used in the present embodiment. For example, in the extraction step S3, a method of putting or immersing the cut pieces in water, or a method of washing the cut pieces with water is employed. In the extraction step S3, the soluble component included in the cut pieces is dissolved in water. When a lithium compound and the like included in the target battery 10 are dissolved in water, the water becomes strongly alkaline.

A mixture including water and the cutting pieces treated in the extraction step S3 is sieved in a sieving step S4, and solid content larger than the sieve opening is collected. The solid content collected in the sieving step S4 is the aluminum plate or aluminum foil used in the positive electrode current collector 31 or the copper foil or copper plate used in the negative electrode current collector 41, for example. In addition, when the target battery 10 to which the laminate material 22 is attached is cut in the cutting step S2, the solid content collected in the sieving step S4 includes fragments of the laminate material 22. A fraction that has passed through the sieve in the sieving step S4 is referred to as a passed fraction. The passed fraction is a mixture of a solid fraction smaller than the sieve opening and an aqueous solution.

The solid content collected in the sieving step S4 is treated in a copper recovery step (not shown), and copper is recovered from the solid content. A remaining fraction after copper has been recovered includes the positive electrode active material (NCM) adhered to a surface of the solid content in addition to aluminum foil and the like. The remaining fraction may be treated together with the passed fraction in a peeling step S5.

In the peeling step S5, the passed fraction from the sieving step S4 is treated together with the aluminum foil including the positive electrode active material collected in the sieving step S4. In the peeling step S5, a treatment of peeling the positive electrode active material from the solid content included in the passed fraction from the sieving step S4 is carried out. Specifically, this treatment is a method of crushing or stirring the passed fraction from the sieving step S4, a method of applying an impact wave to the passed fraction, or the like. Through this treatment, the positive electrode mixture 32 including the positive electrode active material can be separated from the aluminum foil, which is the positive electrode current collector 31, for example. The peeling step S5 corresponds to one example of a separation step.

The passed fraction treated in the peeling step S5 is sieved in a sieving step S6, and solid content larger than the sieve opening is collected. The sieve used in the sieving step S6 has an opening smaller than that of the sieve used in the sieving step S4. That is, in the sieving step S6, filtration with a sieve having an opening smaller than that in the sieving step S4 is carried out, and the solid content is collected. The solid content collected in the sieving step S6 is, for example, a relatively large solid content fraction among the solid content passed in the sieving step S4. The solid content collected in the sieving step S6 mainly originates from the aluminum plate or aluminum foil used in the positive electrode current collector 31 and sometimes includes the copper foil or copper plate used in the negative electrode current collector 41, laminate material 22, and the like.

The passed fraction having passed the sieve in the sieving step S6 is filtered in a filtration step S7. In the filtration step S7, fine solid content and a liquid included in the passed fraction are separated by a filtering media having an opening smaller than that of the sieve in the sieving step S6. Since the liquid separated in the filtration step S7 includes a lithium compound and the like, a lithium recovery treatment (not shown) is conducted. A known method such as Li separation method by ionic conductor (LiSMIC) can be employed to recover lithium.

The solid content collected in the filtration step S7 is subjected to a treatment of removing the binder in a binder removal step S8. In the binder removal step S8, the binder included in the solid content is removed in a treatment environment not causing a change in the forms (such as oxidation) of nickel, cobalt, and manganese included in the positive electrode active material. For example, in the binder removal step S8, a solvent dissolving the binder is added to the solid content, and the binder is dissolved by the solvent to remove the binder. A treatment of removing the solvent and the binder from the solid content can be carried out through filtration or a liquid separation treatment, for example.

In a water dissolution step S9, water is added to the solid content treated in the binder removal step S8. In the water dissolution step S9, a slurry is formed by stirring the solid content and water. The water dissolution step S9 corresponds to one example of a treatment step.

The slurry formed in the water dissolution step S9 is treated in a flotation separation step S10. The flotation separation step S10 is a step of separating, through flotation separation, copper strips originating from the copper member among the solid content included in the slurry. Details of the flotation separation step S10 will be described later.

A recovery step S11 is a step of recovering the positive electrode active material from the slurry separated from copper in the flotation separation step S10. In the recovery step S11, the positive electrode active material is obtained by removing moisture in the slurry, for example. In the recovery step S11, solid content in the slurry is collected through filtration, and the collected solid content is dried, for example. When the solid content is heated during drying, the temperature of the solid content is preferably a temperature not causing a change in the forms (such as oxidation) of nickel, cobalt, and manganese included in the positive electrode active material. Specifically, the temperature of the solid content during drying or the upper limit of the heating temperature is preferably 200° C. or less.

### 3. Details of Flotation Separation Step

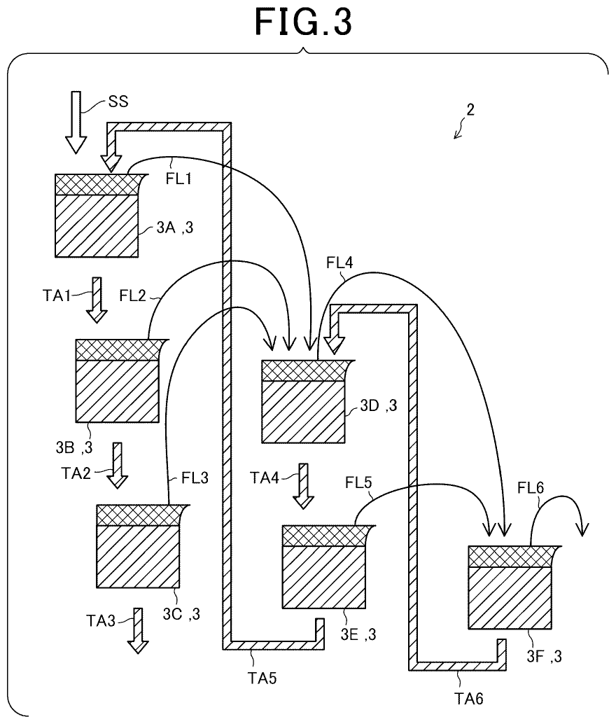

FIG. 3 is a schematic diagram illustrating a treatment example in the flotation separation step S10.

In the flotation separation step S10, for example, a plurality of stages of separation is performed using a flotation separation system 2. In the flotation separation step S10, a collector and a frother are added to the slurry formed in the water dissolution step S9 before separation using the flotation separation system 2. Commercially available flotation separation reagents can be used as the collector and the frother.

The collector is a material having a function to make solvent affinity of a predetermined substance in the slurry hydrophobic and a function to aggregate substances, and various commercially available collectors and flocculants can be used, for example. Examples of the collector include a sulfide-based collector. Specific examples thereof include a product named PAX (manufactured by AIR•MTT, LLC).

The frother may be any component foaming the slurry, and examples thereof include methyl isobutyl carbinol (MIBC), but other frothers may also be used.

The flotation separation system 2 is one example of multi-stage flotation separation using a plurality of separation tanks 3. The collector, the frother, and other additives may be added to the slurry before the slurry is put into the separation tanks 3 shown in FIG. 3. In addition, a treatment of adding the collector, the frother, and other additives to the slurry and stirring same may be carried out in the separation tanks 3.

The flotation separation system 2 selectively collects hydrophobic particles and strips among the components included in the slurry treated in the water dissolution step S9. The hydrophobic particles are, for example, strips of the copper foil or copper plate originating from the copper member.

Separation tanks 3A, 3B, 3C, 3D, 3E, and 3F are used in the flotation separation system 2. In the present embodiment, when these separation tanks are not distinguished one another, the separation tanks are collectively referred to as the separation tank 3.

The slurry formed in the water dissolution step S9 is put into the separation tank 3A. As described above, the collector, the frother, and other additives may be added to the slurry in advance. When the collector, the frother, and other additives are not added to the slurry to be put into the separation tank 3A, the collector and the frother are added in the separation tank 3A and stirred. Other additives may be added at this time.

In the separation tank 3, an aggregated and floated component is referred to as a froth and illustrated with the symbol FL in the diagram. In addition, a liquid or slurry component below the froth in the separation tank 3 is referred to as a tail and illustrated with the symbol TA in the diagram.

In the separation tank 3A, when the slurry is subjected to flotation separation for a predetermined time, hydrophobic particles and strips included in the slurry float, enabling separation of a froth FL1 and a tail TA1. The froth FL1 and the tail TA1 separated in the separation tank 3A are individually taken out, the tail TA1 is put into the separation tank 3B, and the froth FL1 is put into the separation tank 3D described later. The separation tank 3A is, for example, a flotation separation machine having a stirring mechanism (not shown) having a propeller and an air supplying mechanism (not shown). The flotation separation machine stirs the slurry with the propeller, air is supplied to the slurry by the air supplying mechanism, and flotation separation is carried out for a predetermined time.

The tail TA1 put into the separation tank 3B can be separated into a froth FL2 and a tail TA2 through flotation separation of a predetermined time. The froth FL2 is taken out from the separation tank 3B and put into the separation tank 3D. The tail TA2 is taken out from the separation tank 3B and put into the separation tank 3C.

The tail TA2 put into the separation tank 3C can be separated into a froth FL3 and a tail TA3 through flotation separation of a predetermined time. The froth FL3 is taken out from the separation tank 3C and put into the separation tank 3D. The tail TA3 is treated in the recovery step S11.

In this manner, the froths FL1, FL2, and FL3 separated in three stages of the separation tanks 3A, 3B, and 3C are removed, and the slurry formed in the water dissolution step S9 turns into the tail TA3. Since the majority of separable components are removed through flotation separation from the tail TA3, the purity of the positive electrode active material is high. Therefore, the positive electrode active material with fewer impurities can be recovered in the recovery step S11.

The froths FL1, FL2, and FL3 are put into the separation tank 3D. The positive electrode active material included in the froths FL1, FL2, and FL3 is separated in the separation tank 3D and the separation tank 3E. That is, the froths FL1, FL2, and FL3 put into the separation tank 3D can be separated into a froth FL4 and a tail TA4 through flotation separation of a predetermined time. The froth FL4 is collected from the separation tank 3D and put into the separation tank 3F described later. The tail TA4 is put into the separation tank 3E.

The tail TA4 put into the separation tank 3E can be separated into a froth FL5 and a tail TA5 through flotation separation of a predetermined time. The froth FL5 is taken out from the separation tank 3E and put into the separation tank 3F. The tail TA5 is put into the separation tank 3A. The tail TA5 is obtained by taking out most of the positive electrode active material as froths FL1, FL2, FL3, LF4, and FL5 in the separation tanks 3A, 3B, 3C, 3D, and 3E respectively. However, since there is a possibility that hydrophobic solid content is still contained therein, the tail TA5 is not directly sent to the recovery step S11 and is treated again in the separation tank 3A. Consequently, the recovery rate of the positive electrode active material can be improved.

The froths FL4 and FL5 are put into the separation tank 3F. The froths FL4 and FL5 put into the separation tank 3F can be separated into a froth FL6 and a tail TA6 through flotation separation of a predetermined time. The froth FL6 is taken out from the separation tank 3F and treated in the copper recovery step (not shown), as a component mainly including copper, in the same manner as the solid content collected in the sieving step S4, for example. The tail TA6 is put into the separation tank 3D and subjected to flotation separation again.

A stirring mechanism (not shown) having a propeller and an air supplying mechanism (not shown) may be provided to some or all of the separation tanks 3B to 3F as in the separation tank 3A. In a separation tank having the stirring mechanism, flotation separation may be carried out for a predetermined time, while stirring the slurry with the propeller and supplying air to the slurry by the air supplying mechanism.

In the present embodiment, since the deactivation step S1 is carried out under a condition in which a large amount of hydrogen sulfide is generated, a major portion of the copper member of the target battery 10 reacts with hydrogen sulfide to form copper sulfide. Consequently, at least a portion of the surface of the copper component included in the slurry formed in the water dissolution step S9 forms copper sulfide. Copper sulfide is hydrophobic, and the collection effect is enhanced by addition of the sulfide-based collector. Therefore, the copper component included in the slurry can be efficiently collected as a froth in the flotation separation step S10 and easily recovered. In particular, although purity of the positive electrode active material is not easily increased in a state where copper is mixed in the positive electrode active material, when the mixed copper is in a sulfide state, the mixed copper can be effectively separated in the flotation separation step S10. Accordingly, solid content originating from the copper member can be efficiently recovered in the flotation separation step S10, and the positive electrode active material with fewer impurities can be recovered in the recovery step S11.

The present inventors conducted a test in which a positive electrode active material with purity of 80% was made into a slurry having a pulp concentration of 20%, followed by treatment in the flotation separation system 2. As a result, a recovery rate of 95% or more was achieved. In this example, PAX (product name) was used as the collector, and MIBC was used as the frother.

As described above, in the treatment method for the target battery 10 described in the present embodiment, the target battery 10 is an all-solid-state battery that is formed using a copper member and that includes: a positive electrode having a positive electrode mixture 32 including a positive electrode active material; a negative electrode; and a sulfide-based solid electrolyte. This method includes: the deactivation step S1 of deactivating contents of the target battery under a condition facilitating sulfidation of the copper member; and a separation step of separating the positive electrode mixture from a material constituting the positive electrode. The separation step is, for example, the peeling step S5. This method includes: a treatment step of forming a slurry including the positive electrode mixture separated in the separation step; and the flotation separation step S10 of removing, from the slurry, solid content originating from the copper member through flotation separation. The treatment step is, for example, the water dissolution step S9. This method includes the recovery step S11 of recovering the positive electrode active material from the slurry from which the solid content is removed in the flotation separation step S10.

In this manner, by carrying out the deactivation step S1 under a condition facilitating sulfidation of the copper component included in the target battery 10, separation of the copper component in the flotation separation step S10 is made easy. Therefore, the copper component can be efficiently separated in the flotation separation step S10, enabling recovery of a high-purity positive electrode active material in the recovery step S11. Accordingly, when recovering the positive electrode active material including at least one of nickel, cobalt, and manganese, contamination by other metals can be suppressed, thereby improving the recovery efficiency.

The battery treatment method described above deactivates the contents of the target battery 10 in the deactivation process S1 by placing the contents of the target battery 10 in a treatment environment including water vapor.

Consequently, a condition facilitating sulfidation of the copper component included in the target battery 10 can be easily realized.

The battery treatment method described above recovers the positive electrode active material in the recovery step S11 by drying the tail separated from solid content in the flotation separation step S10.

Consequently, the positive electrode active material including at least one of nickel, cobalt, and manganese can be easily recovered.

The battery treatment method described above removes solid content in the flotation separation step S10 through flotation separation by adding a collector and a frother to a slurry.

Consequently, the copper component can be efficiently separated from the slurry including the positive electrode active material in the flotation separation step S10.

In the battery treatment method described above, the copper member is copper foil constituting the negative electrode.

Consequently, when the positive electrode active material is recovered from the target battery 10 using copper foil as the negative electrode, contamination by a component originating from the copper foil can be suppressed, and recovery efficiency can be improved.

### 4. Other Embodiments

The above-descried embodiment is merely one mode of the present invention, and modifications and adaptations can be arbitrarily made without departing from the spirit of the present invention.

In the above-described embodiment, an example in which the target battery 10 having a ternary positive electrode material including nickel, cobalt, and manganese is treated has been described. However, a target of the battery treatment method of the present disclosure is not limited thereto. The battery treatment method of the present disclosure is applicable to a battery using a material including at least one or more of nickel, cobalt, and manganese, with no other limitations.

In addition, the shape of the target battery 10 described in the above-described embodiment is merely one example, and an applicable target of the present disclosure may be a cylindrical or square battery with a casing formed from iron, aluminum, or the like, the casing housing battery materials. That is, the present disclosure is applicable to an all-solid-state battery other than laminated batteries.

### 5. Configurations Supported by Above-Described Embodiment

The above-described embodiment supports the following configurations.

### Configuration 1

A battery treatment method for an all-solid-state battery as a target battery, the all-solid-state battery including a positive electrode, a negative electrode, and a sulfide-based solid electrolyte, with the positive electrode having a positive electrode mixture including a positive electrode active material, the all-solid-state battery being formed using a copper member, the battery treatment method including: a deactivation step of deactivating contents of the target battery under a condition facilitating sulfidation of the copper member; a separation step of separating the positive electrode mixture from a material constituting the positive electrode; a treatment step of forming a slurry including the positive electrode mixture separated in the separation step; a flotation separation step of removing, from the slurry, solid content originating from the copper member through flotation separation; and a recovery step of recovering the positive electrode active material from the slurry from which the solid content is removed in the flotation separation step.

According to the battery treatment method of configuration 1, by carrying out the deactivation step under a condition facilitating sulfidation of a copper component included in the target battery, the copper component can be efficiently separated in the flotation separation step. Therefore, the positive electrode active material of high purity can be recovered in the recovery step. Accordingly, when recovering the positive electrode active material including at least one of nickel, cobalt, and manganese, contamination by other metals can be suppressed, thereby improving recovery efficiency.

### Configuration 2

The battery treatment method according to configuration 1, in which the contents of the target battery are deactivated in the deactivation step by placing the contents of the target battery in a treatment environment including water vapor.

According to the battery treatment method of configuration 2, the condition facilitating sulfidation of the copper component included in the target battery can be easily realized.

### Configuration 3

The battery treatment method according to configuration 1 or configuration 2, in which the positive electrode active material is recovered in the recovery step by drying a tail separated from the solid content in the flotation separation step.

According to the battery treatment method of configuration 3, the positive electrode active material including at least one of nickel, cobalt, and manganese can be easily recovered.

### Configuration 4

The battery treatment method according to any of configuration 1 to configuration 3, in which the solid content is removed through flotation separation by adding a collector and a frother to the slurry in the flotation separation step.

According to the battery treatment method of configuration 4, the copper component can be efficiently separated from the slurry including the positive electrode active material by removing the solid content in the flotation separation step.

### Configuration 5

The battery treatment method according to any of configuration 1 to configuration 4, in which the copper member is copper foil constituting the negative electrode.

According to the battery treatment method of configuration 5, contamination by a component originating from copper foil can be suppressed when the positive electrode active material is recovered from the target battery using copper foil as the negative electrode, thereby improving recovery efficiency.

### REFERENCE SIGNS LIST

2: flotation separation system
3,3A,3B,3D,3E,3F: separation tank
10: target battery
11: positive electrode plate
12: negative electrode plate
13: separator
21: laminated electrode
22: laminate material
32: positive electrode mixture
42: negative electrode mixture

1. A battery treatment method for an all-solid-state battery as a target battery, the all-solid-state battery including a positive electrode, a negative electrode, and a sulfide-based solid electrolyte, with the positive electrode having a positive electrode mixture including a positive electrode active material, the all-solid-state battery being formed using a copper member, the battery treatment method comprising:
a deactivation step of deactivating a content of the target battery under a condition facilitating sulfidation of the copper member;
a separation step of separating the positive electrode mixture from a material constituting the positive electrode;
a treatment step of forming a slurry including the positive electrode mixture separated in the separation step;
a flotation separation step of removing, from the slurry, solid content originating from the copper member through flotation separation; and
a recovery step of recovering the positive electrode active material from the slurry from which the solid content is removed in the flotation separation step.

2. The battery treatment method according to claim 1, wherein the content of the target battery is deactivated in the deactivation step by placing the content of the target battery in a treatment environment including water vapor.

3. The battery treatment method according to claim 1, wherein the positive electrode active material is recovered in the recovery step by drying a tail separated from the solid content in the flotation separation step.

4. The battery treatment method according to claim 1, wherein the solid content is removed through flotation separation by adding a collector and a frother to the slurry in the flotation separation step.

5. The battery treatment method according to claim 1, wherein the copper member is copper foil constituting the negative electrode.
